(19) United States
(12) Patent Application Publication
(10) Pub. No.: US 2011/0243633 A1
(43) Pub. Date: Oct. 6, 2011

(54) TAPE PRINTER

(75) Inventor: Kenichi Nakajima, Shimosuwa-machi (JP)

(73) Assignee: Seiko Epson Corporation, Tokyo (JP)

(21) Appl. No.: 13/050,583

(22) Filed: Mar. 17, 2011

(30) Foreign Application Priority Data
Mar. 30, 2010 (JP) 2010-077502

(51) Int. Cl. B41J 11/42

(52) U.S. Cl. 400/582

(57) ABSTRACT

A tape printer includes: a printing section which performs printing on a tape-shaped material wound around a core to which an end portion of the tape-shaped material is affixed; a feeding section which feeds the tape-shaped material to the printing section; a feeding section driving motor which drives the feeding section; a motor monitoring device which monitors the operation condition of the feeding section driving motor; and a tape end detection device which detects a tape end corresponding to delivery of the end portion of the tape-shaped material based on a monitoring result obtained by the motor monitoring device.

### BACKGROUND

1. Technical Field

The present invention relates to a tape printer which performs various types of printing while gradually delivering a tape wound around a core to which an end portion of the tape is affixed.

2. Related Art

Currently, a tape printer which detects an end or a near end of an ink ribbon used for thermal transfer printing by sensing a transparent end portion of the ink ribbon using a photo-sensor is known (see JP-A-6-99651). In addition, a technology which provides a plurality of sensor marks on an ink ribbon or a printing tape for allowing a photo-sensor to detect an end is known as a technology similar to the above tape printer (see JP-A-9-300764).

However, when the tape end is detected by using the above methods, a component such as a sensor for detection needs to be added to the tape printer. Moreover, the necessity for adding a portion not for printing such as a light-transmissive film to the end portion of the tape for allowing the sensor to detect the tape end as the method in JP-A-6-99651, and the necessity for providing the marks for the sensor as the method in JP-A-9-300764 complicate the structure of the tape. In case of the technology which adds the marks for the sensor, such a tape which has patterns on the entire area of the tape is difficult to be used, for example, for preventing malfunction in some cases.

### SUMMARY

An advantage of some aspects of the invention is to provide a tape printer which performs tape printing while feeding a tape wound around a core and easily detects a tape end.

A tape printer according to an aspect of the invention includes: a printing section which performs printing on a tape-shaped material wound around a core to which an end portion of the tape-shaped material is affixed; a feeding section which feeds the tape-shaped material to the printing section; a feeding section driving motor which drives the feeding section; a motor monitoring device which monitors the operation condition of the feeding section driving motor; and a tape end detection device which detects a tape end corresponding to delivery of the end portion of the tape-shaped material based on a monitoring result obtained by the motor monitoring device.

According to this tape printer, the tape end detection device detects the tape end of the tape-shaped material based on the monitoring result of the operation condition of the feeding section driving motor monitored by the motor monitoring device. Thus, the tape end of the tape-shaped material can be detected relatively easily and accurately. Moreover, the motor monitoring device monitoring the operation condition of the feeding section driving motor is a component already equipped. Accordingly, the necessity for providing additional sensors and the like for tape end detection can be eliminated.

According to a specific aspect of the invention, the tape end detection device detects the tape end when the motor monitoring device determines that a load on the feeding section driving motor is increased by a predetermined value or higher. In this case, the condition in which the load on the feeding section driving motor increases by the bonding between the end portion of the tape-shaped material and the core is monitored. The tape end detection device can detect the tape end based on the monitoring result concerning this load increase.

According to another aspect of the invention, the tape end detection device detects the tape end when the motor monitoring device determines that the condition where the load on the feeding section driving motor is increased by the predetermined value or higher is kept. In this case, the condition in which the load on the feeding section driving motor is kept high by the state of the end portion of the tape-shaped material affixed to the core without releasing therefrom is monitored. The tape end detection device can detect the tape end based on the monitoring result concerning this load increase.

According to still another aspect of the invention, the tape end detection device detects the tape end when the motor monitoring device determines that a load on the feeding section driving motor is decreased by the predetermined value or higher. In this case, the condition in which the load on the feeding section driving motor decreases by the release of the end portion of the tape-shaped material from the core is monitored. The tape end detection device can detect the tape end based on the monitoring result concerning this load decrease.

According to yet another aspect of the invention, the tape end detection device detects the tape end when the motor monitoring device determines that the load on the feeding section driving motor rises to the predetermined value or higher and then lowers. In this case, the change of the condition in which the load on the feeding section driving motor temporarily increases for separation of the end portion of the tape-shaped material from the core and then decreases after release of the end portion from the core is monitored. The tape end detection device can detect the tape end based on the monitoring result concerning this series of changes of the load.

According to still yet another aspect of the invention, the motor monitoring device monitors the rotation of the feeding section driving motor, and the tape end detection device detects the tape end based on a load necessary for maintaining the number of the rotations of the feeding section driving motor. In this case, the change of the load on the feeding section driving motor can be recognized relatively easily and accurately for detecting the tape end.

According to further another aspect of the invention, the feeding section driving motor is a DC motor, the motor monitoring device has an encoder which outputs information about the rotation speed of the DC motor and performs feedback control for changing the duty ratio of a PWM waveform based on the information about the rotation speed outputted from the encoder, and the tape end detection device determines the tape end from the change of the duty ratio of the PWM waveform. In this case, the rotation speed of the feeding section driving motor can be kept constant by the feedback control even when the load imposed on the DC motor varies. Thus, the tape end can be easily and accurately determined based on the information about the duty ratio associated with the feedback control.

According to still further another aspect of the invention, the printing section prints information about the tape end on the tape-shaped material when the tape end is detected. In this case, the information about the tape end can be printed on the tape-shaped material and remain thereon even when the power source of the tape printer is turned off after tape end detection, for example. Thus, this information can be securely confirmed.

### BRIEF DESCRIPTION OF THE DRAWINGS

The invention will be described with reference to the accompanying drawings, wherein like numbers reference like elements.

FIG. 1 is a perspective view illustrating the external appearance of a tape printer according to a first embodiment.

FIG. 2A is a perspective view illustrating the external appearance of the tape printer whose cover is opened.

FIG. 2B is a perspective view illustrating the external appearance of a tape cartridge attached to the tape printer.

FIG. 3 schematically illustrates the condition of a tape during feeding.

FIG. 4A is a block diagram showing an entire control system of the tape printer.

FIG. 4B is a block diagram showing a part of the control system as the part associated with detection of a tape end.

FIG. 5A is a graph showing a change of a load during tape feeding.

FIGS. 5B through 5D schematically illustrate the conditions of the tape end in correspondence with the change of the load.

FIG. 6 is a flowchart showing an example of a process for detecting the tape end.

FIGS. 7A and 7B show examples of a tape on which information about the tape end is printed at the time of the tape end.

FIG. 8A is a graph showing a change of a load of a tape printer according to a second embodiment during tape feeding.

FIG. 8B schematically illustrates the condition of a tape end.

FIG. 9 is a flowchart showing an example of a process for detecting the tape end.

### DESCRIPTION OF EXEMPLARY EMBODIMENTS

### First Embodiment

A tape printer according to a first embodiment is hereinafter described with reference to the drawings.

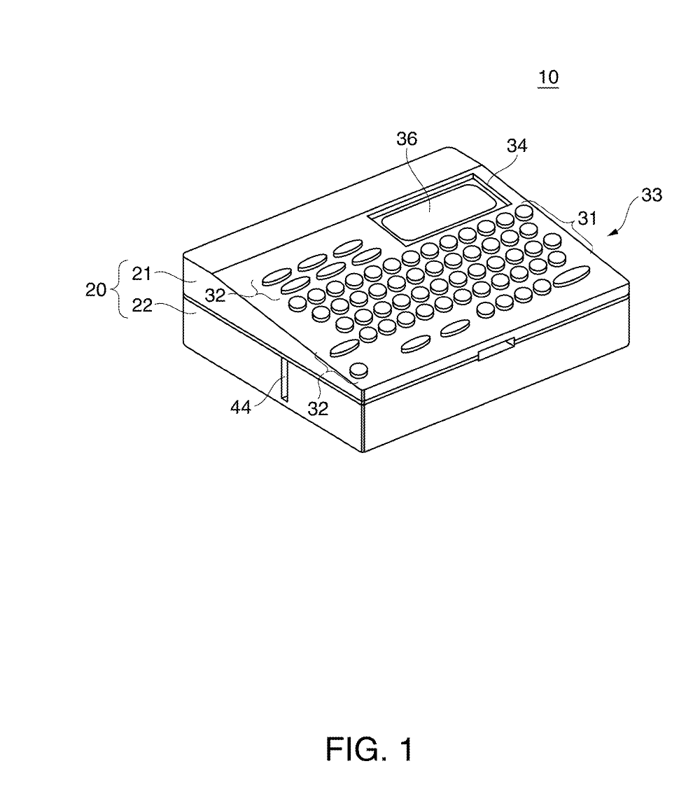

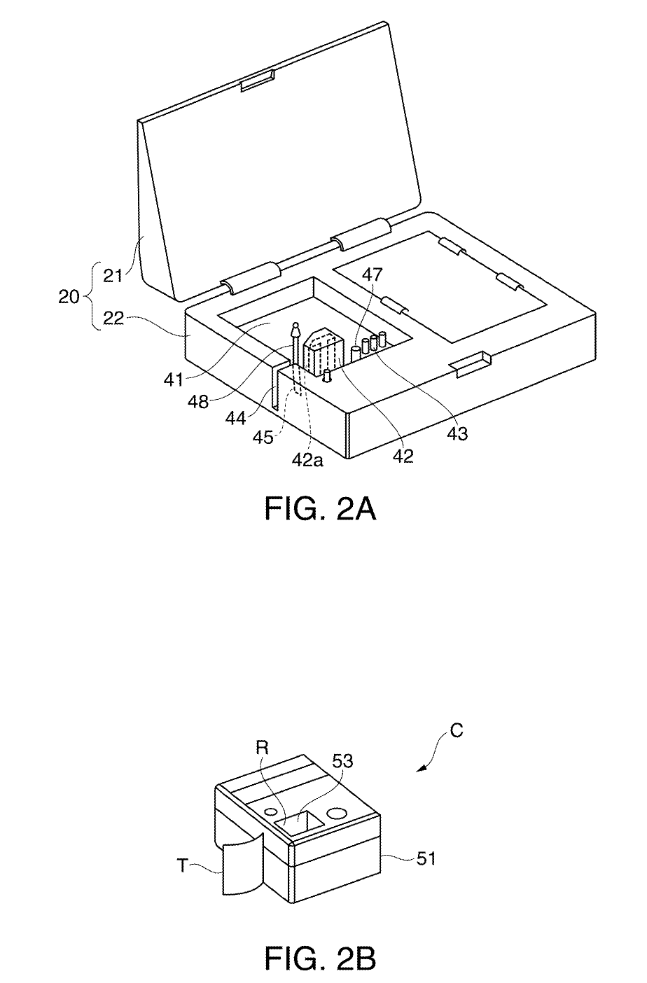

FIG. 1 is a perspective view illustrating the general structure of the tape printer in this embodiment. FIG. 2A is a perspective view of the tape printer shown in FIG. 1 with its open/close cover opened. FIG. 2B is a perspective view of a tape cartridge attached to the tape printer.

As illustrated in FIGS. 1, 2A and 2B, a tape printer 10 in this embodiment has a device case 20 divided into two parts on the upper side and the lower side for constituting the external casing of the tape printer 10. The device case 20 has an upper case 21 as the open/close cover, and a lower case 22 which contains mechanical sections such as a pocket 41 to which a tape cartridge C is (can be) attached.

A keyboard 33 and a display 34 are provided on the front part and the right rear part, respectively, of the upper surface of the upper case 21. The upper case 21 is closed during use except for the time when the tape cartridge C is attached and detached.

The keyboard 33 is a unit through which information such as data and commands are inputted as information transmitted to a microcomputer chip or the like as a control system contained in the lower case 22. The keyboard 33 includes a group of character keys 31 used when inputting text information such as characters, symbols, and numerals, a group of function keys 32 used when specifying various types of operation mode and the like, and other keys arranged on the surface.

The display 34 has a display screen 36 which can display n rows×m lines (n and m are appropriate natural numbers) of arbitrary character strings and the like in the horizontal direction and the vertical direction, and can display process results and commands produced by the microcomputer chip and others as the control system contained in the lower case 22. More specifically, the display 34 is used when a user selects or edits character strings and others after inputting data, various commands and requests and the like through the keyboard 33, or visually recognizes the results and others.

The lower case 22 has the pocket 41 to which the tape cartridge C is attached. The tape cartridge C is attached to and detached from the pocket 41 with the upper case (open/close cover) 21 opened. The tape cartridge C contains a tape T and an ink ribbon R each having a constant width inside a cartridge case 51. The tape cartridge C further has a through hole 53 into which a head unit 42 provided on the pocket 41 is inserted.

The tape T constitutes the main body of a tape-shaped material as a printing target, and has an adhesive surface on its back side as a surface covered with released paper. The tape T and the ink ribbon R overlap with each other while traveling through the through hole 53. Then, only the tape T is discharged to the outside, and the ink ribbon R is wound inside.

The head unit 42 provided at an appropriate position of the pocket 41 contains a printing head 42a having a thermal head. The printing head 42a is disposed in such a position as to contact the back surface of the ink ribbon R exposed through the through hole 53 of the tape cartridge C when the tape cartridge C is attached to the pocket 41. In this condition, desired characters and the like can be printed on the surface of the tape T by the heating operation of the printing head 42a.

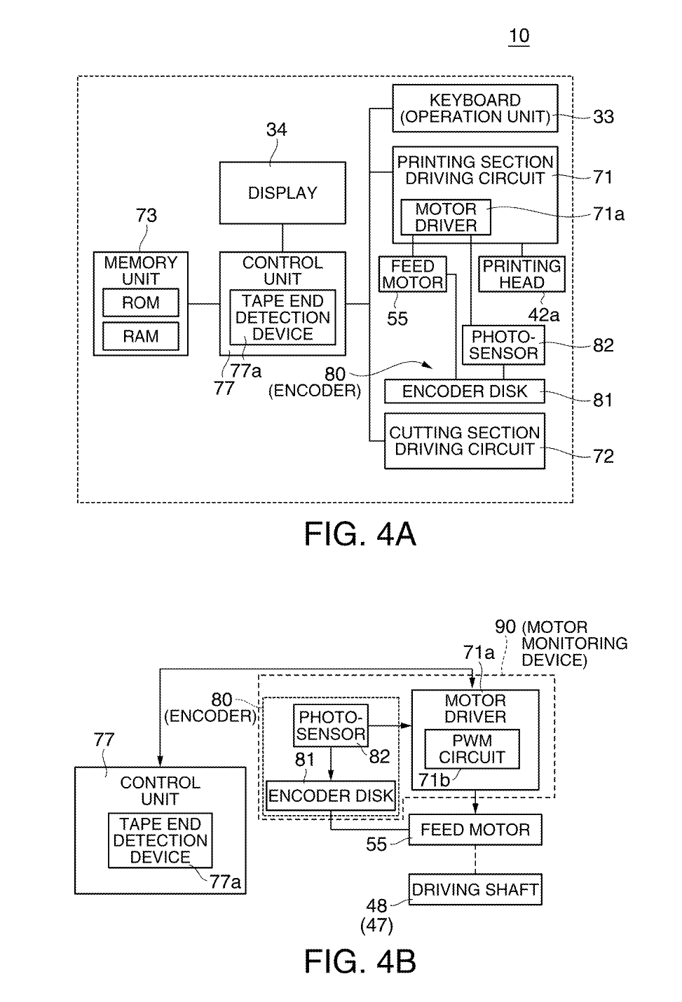

A tape outlet port 44 connecting the pocket 41 and the outside of the device is formed on the left side surface of the lower case 22. The tape outlet port 44 faces to a tape cutter 45 for cutting the delivered tape T. A ribbon driving shaft 47 and a roller driving shaft 48 engaging with a driven part of the attached tape cartridge C are provided on the pocket 41. The ink ribbon R and the tape T within the tape cartridge C are delivered by the driving shafts 47 and 48 driven by a built-in feed motor 55 (see FIG. 4B and other figures) as a driving source. Simultaneously, the printing head 42a is operated in synchronization with the driving shafts 47 and 48 for performing printing. After completion of printing, the delivery of the tape T is continued until the cutting position determined for the tape T reaches the position of the tape cutter 45.

According to a typical method for using the tape printer 10 having this structure, the user initially attaches the tape cartridge C to the pocket 41, and requests printing by inputting printing information such as desired characters and symbols through the keyboard 33 while checking the input/edition results shown on the display 34. In response to this request, the tape T is drawn from the tape cartridge C, and the desired printing is performed on the tape T by the operation of the printing head 42a. Then, the printed portion is sequentially discharged through the tape outlet port 44 to the outside. After completion of printing, the tape feeding is continued until the tape T reaches the position of the tape length including a margin, where the tape T is cut at a predetermined position to be formed into a label.

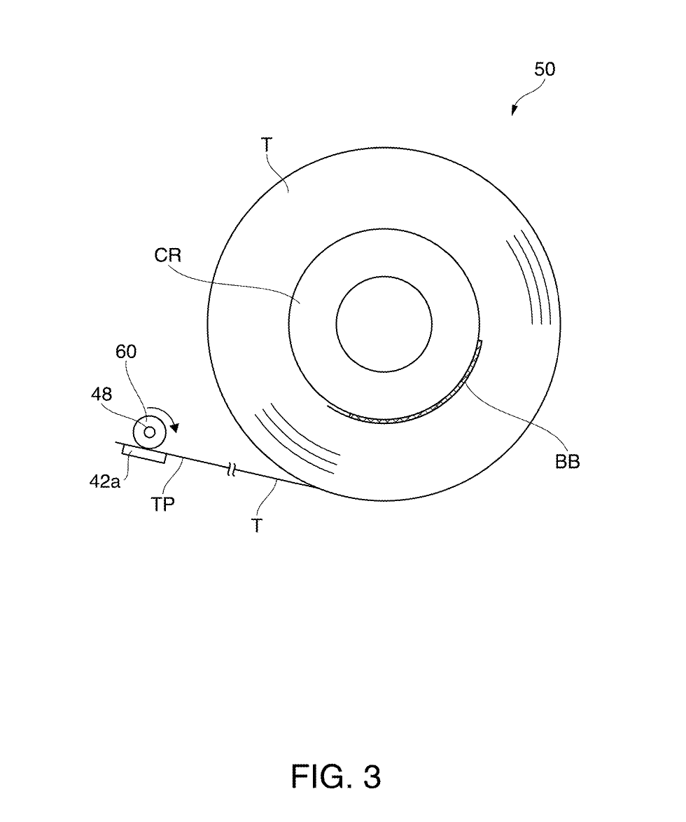

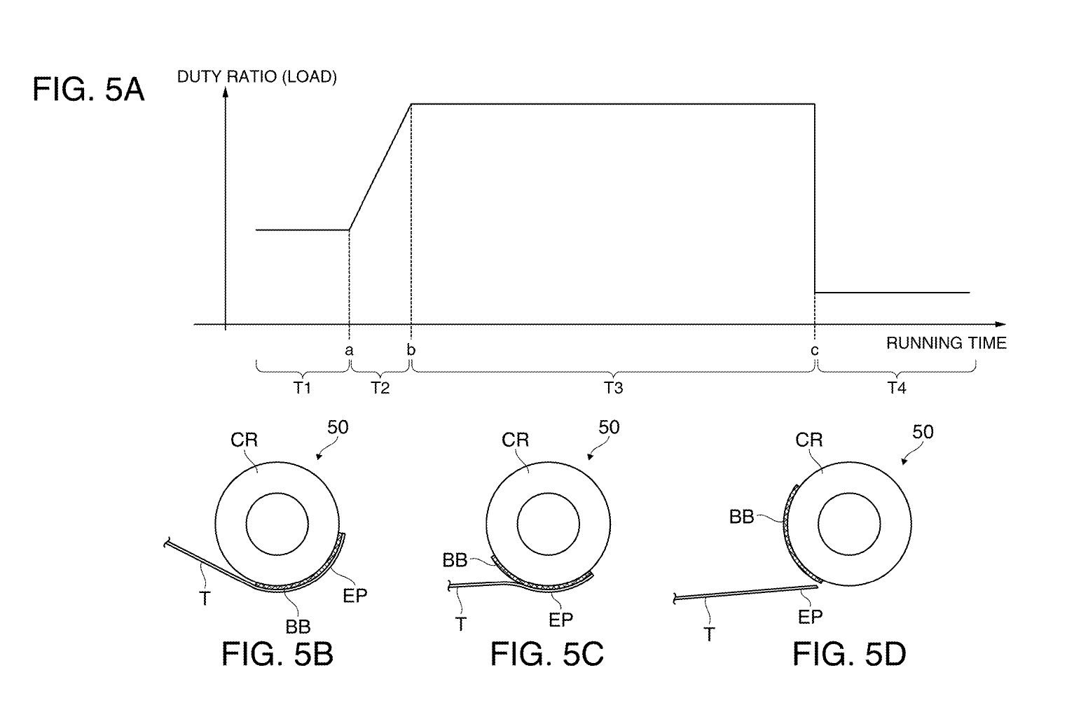

The tape T contained in the tape cartridge C shown in FIG. 2B, and a winding tape 50 as a tape-shaped material including the tape T as the main body are now described with reference to FIG. 3. The winding tape 50 has a core CR, an adhesive double coated tape BB, and the tape T. An end portion EP (see FIG. 5B) of the elongate belt-shaped tape T is affixed to the core CR by a bonding force of certain strength by using the adhesive double coated tape BB, and wound around the core CR. The tape T wound in this condition is drawn by the roller driving shaft 48 of the tape printer 10. More specifically, a leading portion TP of the tape T is sandwiched between a platen roller 60 engaging with the roller driving shaft 48 as the driven part of the tape cartridge C and the printing head 42a urged toward the platen roller 60, and is drawn out in accordance with the rotation of the platen roller 60 driven by the roller driving shaft 48. Thus, the roller driving shaft 48 and the platen roller 60 driven by the roller driving shaft 48 function as a feeding section for feeding the tape T.

The structure of a control system of the tape printer 10 shown in FIG. 1 and other figures is now explained with reference to FIG. 4A. The tape printer 10 includes the keyboard 33 and the display 34 functioning as the interface with the user as described above, and further includes a printing section driving circuit 71 for driving the printing head 42a and the feed motor 55 as the feeding section driving motor, an encoder disk 81 fixed to a rotation shaft of the feed motor 55 to detect the rotation condition of the rotation shaft, a photo-sensor 82 which detects ON/OFF timing corresponding to the rotation of the encoder disk 81 and transmits the detection result to a motor driver 71a of the printing section driving circuit 71, a cutting section driving circuit 72 which allows the tape cutter 45 to perform cutting, a memory unit 73 which stores data, calculation results and the like, and a control unit 77 which controls and operates the respective circuits in appropriate manners.

In this structure, the printing head 42a and the printing section driving circuit 71 function as a printing section for performing printing on the tape T. The encoder disk 81 and the photo sensor 82 function as an encoder 80 for detecting the condition of the rotation speed of the feed motor 55.

The motor driver 71a of the printing section driving circuit 71 controls the feed motor 55 based on signals received from the photo-sensor 82 such that the speed for feeding the tape T as the printing target can be kept constant. Thus, the motor driver 71a performs feedback control of the feed motor 55 as a DC motor by using the encoder 80.

The control unit 77 includes a microcomputer chip and others. The memory unit 73 includes an IC having ROM and RAM. The control unit 77 operates according to a control program contained in the ROM of the memory unit 73 to control the overall operation of the tape printer 10. For example, the control unit 77 receives inputs of various commands, various detection signals and the like from the keyboard 33 and others, processes various data and the like received from the RAM of the memory unit 73, and outputs control signals to the display 34, the printing section driving circuit 71, the cutting section driving circuit 72 and others to allow the display screen 36 to display necessary indications and allow the printing head 42a to perform printing on the tape T in a predetermined printing condition by controlling the printing head 42a. The control unit 77 particularly obtains information concerning the feedback control, more specifically, information about the load on the feed motor 55 and the like from the motor driver 71a. The control unit 77 has a tape end detection device 77a for detecting a tape end condition which corresponds to the state of the winding tape 50 coming to the used up condition within a short period after drawing all the wound tape T and delivering the end portion EP.

An example of the operation for monitoring the feed motor 55 and the operation for detecting the tape end based on the monitoring result executed by the tape printer 10 is now explained with reference to FIG. 4B as one of the printing operation performed by the tape printer 10. FIG. 4B shows a part of the whole control system shown in the block diagram in FIG. 4A as the part of the control system associated with the monitoring of the feed motor 55 and the detection of the tape end corresponding to the used up condition of the tape T.

The motor driver 71a included in the circuit part in FIG. 4B provides feedback control based on the information received from the encoder 80. More specifically, the encoder disk 81 axially rotates with the rotation shaft of the feed motor 55, and the photo-sensor 82 detects the rotation of the encoder disk 81 and outputs information on the rotation speed (number of revolutions) of the feed motor 55 to the motor driver 71a. The motor driver 71a performs calculation based on the detection information obtained from the photo-sensor 82, and outputs a PWM waveform control signal corresponding to the calculation result. That is, when the rotation speed (number of revolutions) of the feed motor 55 deviates from a target value, the duty ratio of the PWM waveform, i.e., the proportion of the power source ON period is varied such that the deviation can be corrected. More specifically, when the rotation speed decreases, the duty ratio of the PWM waveform is raised by the amount corresponding to the decrease. When the rotation speed increases, the duty ratio of the PWM waveform is lowered by the amount corresponding to the increase.

Accordingly, the motor driver 71a determines a necessary standard duty ratio of the PWM waveform based on the detection information outputted from the photo-sensor 82 and the conditions such as the specification of the feed motor 55 and the resistance of the feeding section, and drives the feed motor 55 while changing the standard duty ratio such that increase and decrease in the rotation speed is not produced so as to keep the number of revolutions of the feed motor 55 constant. That is, the motor driver 71a keeps the rotation speed of the feed motor 55, i.e., the feeding speed of the tape T substantially constant by controlling the load condition of the feed motor 55 as the feeding section driving motor. In this case, the motor driver 71a and the encoder 80 function as a motor monitoring device 90 which monitors the load condition of the feed motor 55.

The tape end detection device 77a of the control unit 77 receives information about the rotation of the feed motor 55 as the monitoring result from the motor monitoring device 90. More specifically, the tape end detection device 77a sequentially reads the duty ratio of the PWM waveform determined by the motor driver 71a as the load on the feed motor 55, and determines whether the tape T is in the tape end condition based on this information.

FIG. 5A is a graph showing the load changes when the end portion EP of the winding tape 50 wound around the core CR is released from the adhesive double coated tape BB. The horizontal axis in FIG. 5A indicates the running time of the tape T which corresponds to the running length of the tape T. The vertical axis indicates the duty ratio as an example of the level of the load imposed on the motor.

At the time of the tape end after completion of feeding the tape T, the load on the feed motor 55 detected by the tape end detection device 77a varies as shown in FIG. 5A. In this case, the condition of the winding tape 50 changes with steps as shown in FIGS. 5B through 5D. During this change, the end portion EP of the tape T wound around the core CR is gradually released from the adhesive double coated tape BB, and finally only the core CR and the adhesive double coated tape BB are left. Thus, almost all part of the tape T including the end portion EP can be used for printing.

The relationship between the tape T and the load on the feed motor 55 under the tape end condition is now specifically explained.

FIG. 5B shows the condition in which an effect on the load produced by bonding between the tape T and the adhesive double coated tape BB is started to be recognized. This condition corresponds to the state of a term T2 continuing from a point a to a point b as time points. That is, the load necessary for releasing the tape T from the adhesive double coated tape BB starts to be imposed. Thus, the motor driver 71a detects a rapid rise of the load within a short period.

FIG. 5C shows the condition in which the end portion EP of the tape T is being released from the adhesive double coated tape BB. This condition corresponds to a term T3 from a point b to a point c in FIG. 5A. In this case, the motor driver 71a detects that the high load condition is maintained for continuing release of the end portion EP.

FIG. 5D shows the condition of the tape end in which the end portion EP of the tape T is released from the adhesive double coated tape BB and separated from the core CR. This condition corresponds to a term T4 after the point c in FIG. 5A. In this case, no load is produced after separation between the tape T and the adhesive double coated tape BB, and also the load required for rotating the winding tape 50 while drawing the necessary tape T in the normal delivery is not generated. Thus, the motor driver 71a detects that the load after the point c is lower than the load before the point a as the normal load.

The tape end detection device 77a detects whether the winding tape 50, that is, the tape T is in the tape end condition based on the change of the load detected by the motor driver 71a.

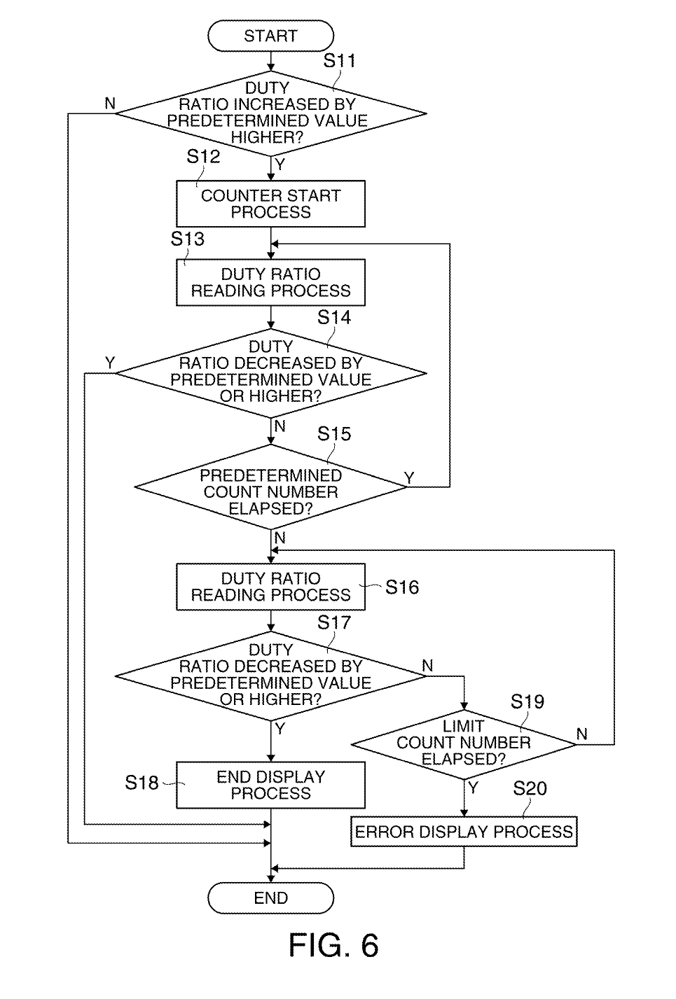

An example of the operation for detecting the tape end at the time of tape end is now explained with reference to FIG. 6. The tape end detection device 77a of the control unit 77 constantly detects the change of the duty ratio (step S11). More specifically, a threshold for the duty ratio is determined in advance, and whether the duty ratio is equivalent to or higher than the threshold is detected for every 5 steps of the tape feeding by the feed motor 55, for example, to check the presence or absence of the load increase.

When it is detected that the duty ratio is equal to or higher than the predetermined threshold in step S11 (step S11: Y), the tape end detection device 77a determines that there is a load increase in the term T2 in FIG. 5A and thus a possibility of the tape end, and then determines whether the condition in the term T3 as the next stage in which the high load is maintained for releasing the tape T is produced. For this determination, the tape end detection device 77a initially starts a counter (step S12), and reads the duty ratio (step S13) to determine whether the duty ratio is maintained equal to or higher than the threshold (step S14). These operations in the steps S13 and S14 are continued for the period shown in the term T3, that is, until the detection reaches a predetermined count number (step S15). In this embodiment, 1 count corresponds to 5 steps of the tape feeding, and the predetermined count number is 20, for example. When it is determined that the duty ratio is lowered in the step S14 (step S14: Y) before the count number 20 (step S15: N), the tape end detection device 77a determines that the rise of the duty ratio detected in the step S11 is caused not by the possibility of the tape end but by a temporary load change produced for other reasons. Thus, the tape end detection device 77a finishes the process without providing end display.

When the detection reaches the predetermined count number in the step S15 (step S15: Y) with constant determination that the duty ratio is not lowered (step S14: N), the tape end detection device 77a determines that the condition in the term T3 in FIG. 5A is produced, and then determines whether the condition in the term T4 as the next stage in which the tape T is released is produced. In this case, it is considered that there is a slight timing error in the shift from the condition in the term T3 to the condition in the term T4, that is, the timing for releasing the tape T. Thus, the duty ratio is again read (step S16) to determine whether the duty ratio is lowered to a value below the threshold (step S17). In this case, the operations in the steps S16 and S17 are continuously repeated for a predetermined period.

When it is determined that the duty ratio is lowered in the step S17 (step S17: Y), the tape end detection device 77a determines that the tape T is in the tape end condition as in the term T4 in FIG. 5A, and starts a process for displaying the tape end (step S18). That is, the control unit 77 allows the display 34 and other components to notify the user about the tape end.

When it is determined that the duty ratio is not lowered in the step S17 (step S17: N), the tape end detection device 77a checks whether the detection has reached a limit count number determined in advance considering the timing error in the release of the tape T (step S19). In this embodiment, the limit count number is determined as an elapse of the counter number 30 after the count number 20 counted in the step S15. Before the limit count number (step S19: N), the tape end detection device 77a reads the duty ratio until the detection reaches the limit count number to check whether the duty ratio is lowered (steps S16 and S17). When it is determined that the duty ratio is lowered (step S17: Y), the tape end detection device 77a determines that the tape T is in the tape end condition as in the term T4 in FIG. 5A, and executes the process for displaying the tape end (step S18). When the detection reaches the limit count number (step S19: Y) without detection of decrease in the duty ratio (step S17: N), the tape end detection device 77a determines that a high load is kept imposed due to some abnormal conditions such as tape jamming, and conducts a process for displaying error (step S20).

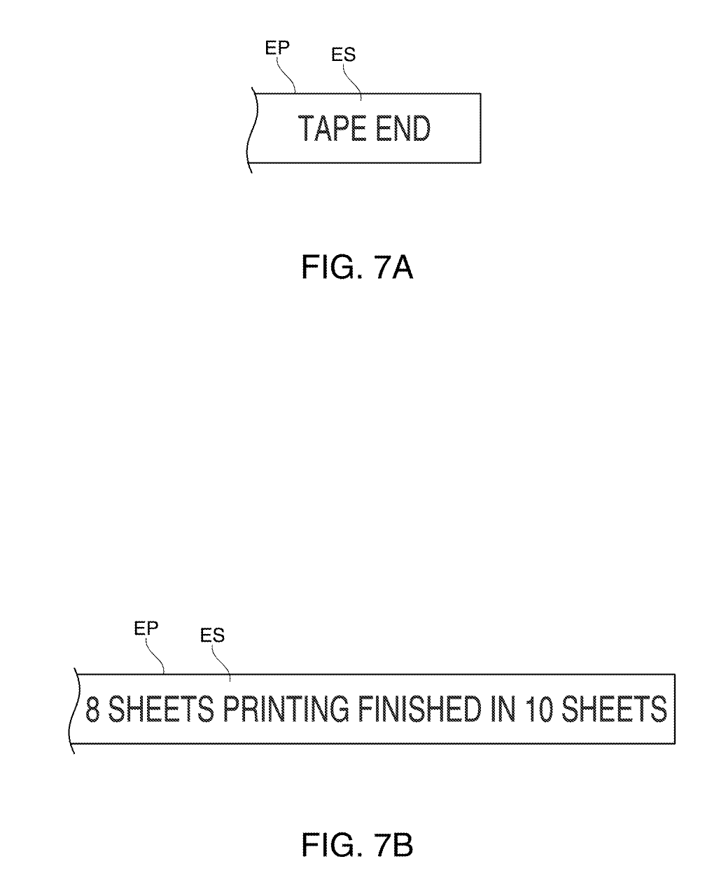

For displaying the tape end in the step S18, an indication of the end of the tape T may be printed on a printing surface ES of the end portion EP of the tape T as illustrated in FIG. 7A, for example, to notify the user about the tape end instead of notification of the tape end on the display 34. When the tape T is finished during successive printing, the condition that printing for eight sheets contained in ten sheets in total for successive printing is finished may be printed on the printing surface ES as printing on the printing surface ES as illustrated in FIG. 7B, for example. In this case, the detection of the tape end remains in the printed condition on the tape T even when the display or the like on the display 34 disappears by turning off the power source of the tape printer 10 after detection of the tape end, for example. Thus, the user can confirm the condition of the tape end.

According to the tape printer 10 in this embodiment, the tape end detection device 77a detects the tape end of the tape T based on the monitoring result of the operation condition of the feed motor 55 monitored by the motor monitoring device 90 constituted by the motor driver 71a and the encoder 80. Thus, the tape end of the tape T can be detected relatively easily and accurately. Moreover, the motor driver 71a and the like monitoring the operation condition of the feed motor 55 are components already equipped for adjusting the speed of the feed motor 55 to a constant speed or for other purposes. Accordingly, the necessity for providing additional sensors and the like for detecting the tape end is eliminated, and thus the structure can be simplified.

According to this embodiment, the tape end detection device 77a performs detection based on the result of the duty ratio monitored by the motor driver 71a. However, various types of information other than the duty ratio can be used for tape end detection as long as the information shows the rotation of the feed motor 55 based on which information the change of the load can be accurately recognized such as the result obtained by monitoring the change of the effective voltage of the feed motor 55 or the like.

According to this embodiment, it is determined whether the present condition is the tape end condition or not by detecting the change of the load during the period from the term T1 to the term T4. However, the tape end can be detected based on the determination that the load on the feed motor 5 is raised to the predetermined value or higher considering this state as the change from the condition in the term T1 to the condition in the term T3. That is, the tape end detection device 77a may determine that the winding tape 50 is in the tape end condition corresponding to the change from the condition in FIG. 5B to the condition in FIG. 5C based on the load increase, and then the control unit 77 may allow display of this state.

Moreover, the tape end can be detected based on the determination that the condition in the term T3 in FIG. 5A has been changed to the condition in the term T4 based on the load decrease of the feed motor 55 is decreased by the predetermined value or higher. More specifically, the tape end detection device 77a may detect the tape end condition of the winding tape 50 corresponding to the change from the condition in Fig. FIG. 5C to the condition in FIG. 5D based on the load decrease, and then the control unit 77 may allow display of this state. When the bonding force of the adhesive double coated tape BB is relatively small, for example, remarkable load increase cannot be recognized. In this case, only the load decrease caused by the absence of the rotational moment of the winding tape 50 after release of the end portion EP as shown in FIG. 5D becomes remarkable. Even in this situation, the tape end can be securely detected by the tape end detection device 77a constructed as above based on the load decrease.

### Second Embodiment

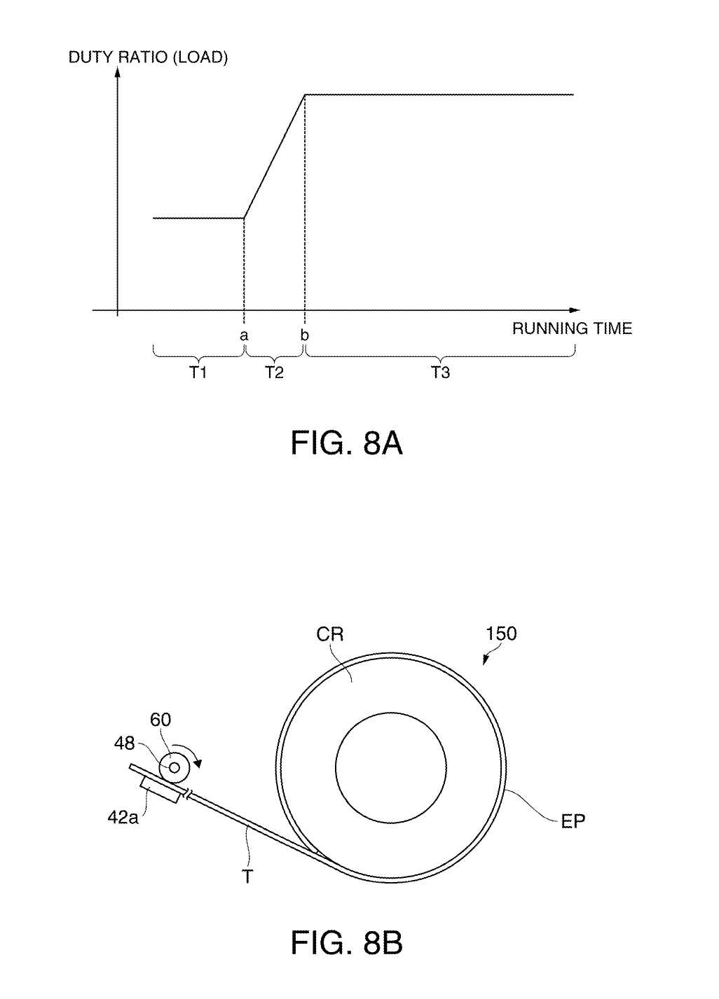

A tape printer according to a second embodiment is now described with reference to FIG. 8A and other figures. The tape printer in this embodiment is a modification of the tape printer 10 in the first embodiment shown in FIG. 1 and other figures, and has a structure similar to that in the first embodiment other than the parts particularly explained herein.

FIG. 8A is a graph showing the change of the load of the tape printer according to this embodiment during tape feeding. More specifically, similarly to the graph shown in FIG. 5A, the horizontal axis in FIG. 8A indicates the running time or the running length of the tape T, while the vertical axis indicates the level of the load imposed on the motor, i.e., the duty ratio. FIG. 8B schematically illustrates the condition of the tape end. As illustrated in FIG. 8B, the end portion EP of the tape T of a winding tape 150 is directly affixed to the core CR and wound therearound. In this structure, the bonding force between the end portion EP and the core CR is larger than the force for delivering the tape T by the feed motor 55, and thus the end portion EP is not released from the core CR at the time of the tape end. As a result, the load equal to or higher than the predetermined value is kept imposed on the feed motor 55 in the term T3 in FIG. 8A. More specifically, at the time of the tape end, the load kept substantially constant during the normal operation in the term T1 increases within a short period in the term T2, thereafter the maximum load is maintained in the term T3. Under this state, a condition for locking the tape feeding is produced. According to this embodiment, the tape end detection device 77a detects this condition as the tape end.

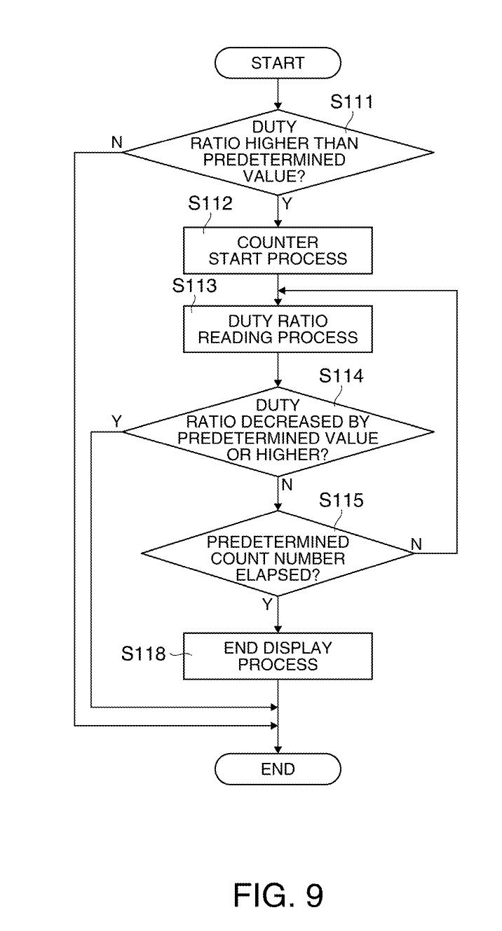

An example of the operation for detecting the tape end at the time of the tape end is now explained with reference to the flowchart shown in FIG. 9. The tape end detection device 77a reads the duty ratio for every 5 steps of the tape feeding by the feed motor 55, and executes the process for starting the counter (step S112) when detecting that the duty ratio is equal to or higher than the threshold (step S111: Y). Then, the tape end detection device 77a reads the duty ratio (step S113) and determines whether the duty ratio is kept equal to or higher than the threshold (step S114). The tape end detection device 77a continues this operation until the detection reaches the predetermined count number (step S115). When it is determined that the duty ratio is lowered in the step S114 (step S114: Y), the tape end detection device 77a determines that the detection result in the step S111 is produced not by the possibility of the tape end but by a temporary change of the load caused for other reasons. Thus, the tape end detection device 77a finishes the process without end display. When the detection reaches the predetermined count number in the step S115 (step S115: Y) with continuous determination that the duty ratio is not lowered in the step S114 (step S114: N), the tape end detection device 77a determines that the condition in the term T3 in FIG. 8A is produced and performs the process for displaying the tape end (step S118).

According to the tape printer in this embodiment, the tape end detection of the tape T can be performed relatively easily and accurately based on the monitoring result of the operation condition of the feed motor 55 similarly to the first embodiment.

### MODIFIED EXAMPLES AND OTHERS

The invention is not limited to the embodiments described herein but may be practiced in various other ways without departing from the scope of the invention. For example, the following modifications may be made.

According to the respective embodiments, the change of the load is checked for the tape end detection by monitoring the change of the duty ratio. However, the tape end can be detected by monitoring the change of the effective voltage or the change of the current, power consumption or the like.

According to the first embodiment in the respective embodiments, for example, the duty ratio is checked for every 5 steps of the tape feeding by the feed motor 55 in the step S11. However, this interval is only an example, and the frequency of checking the presence or absence of the change can be determined according to the relationship between the driving force of the used feed motor 55 and the bonding force of the end portion EP of the tape T, the length of the end portion EP, and other conditions. This applies to the threshold for checking the increase and decrease of the duty ratio, the count numbers and the like.

The entire disclosure of Japanese Patent Application No. 2010-77502, filed Mar. 30, 2010 is expressly incorporated by reference herein.

What is claimed is:

1. A tape printer comprising:
a printing section which performs printing on a tape-shaped material wound around a core to which an end portion of the tape-shaped material is affixed;
a feeding section which feeds the tape-shaped material to the printing section;
a feeding section driving motor which drives the feeding section;
a motor monitoring device which monitors the operation condition of the feeding section driving motor; and
a tape end detection device which detects a tape end corresponding to delivery of the end portion of the tape-shaped material based on a monitoring result obtained by the motor monitoring device.

2. The tape printer according to claim 1, wherein the tape end detection device detects the tape end when the motor monitoring device determines that a load on the feeding section driving motor is increased by a predetermined value or higher.

3. The tape printer according to claim 2, wherein the tape end detection device detects the tape end when the motor monitoring device determines that the state where the load on the feeding section driving motor is increased by the predetermined value or higher is maintained.

4. The tape printer according to claim 1, wherein the tape end detection device detects the tape end when the motor monitoring device determines that a load on the feeding section driving motor is decreased by the predetermined value or higher.

5. The tape printer according to claim 4, wherein the tape end detection device detects the tape end when the motor monitoring device determines that the load on the feeding section driving motor rises to the predetermined value or higher and then lowers.

6. The tape printer according to claim 1, wherein:
the motor monitoring device monitors the rotation of the feeding section driving motor; and
the tape end detection device detects the tape end based on a load necessary for maintaining the number of the rotations of the feeding section driving motor.

7. The tape printer according to claim 6, wherein:
the feeding section driving motor is a DC motor;
the motor monitoring device has an encoder which outputs information about the rotation speed of the DC motor and performs feedback control for changing the duty ratio of a PWM waveform based on the information about the rotation speed outputted from the encoder; and
the tape end detection device determines the tape end from the change of the duty ratio of the PWM waveform.

8. The tape printer according to claim 1, wherein the printing section prints information about the tape end on the tape-shaped material when the tape end is detected.

9. A tape printing control method, comprising the steps of:
printing on a tape-shaped material wound around a core to which an end portion of the tape-shaped material is affixed;
feeding the tape-shaped material to the printing section by a driving motor;
monitoring the operation condition of the driving motor; and
detecting a tape end corresponding to delivery of the end portion of the tape-shaped material based on monitoring result.

10. The tape printing control method according to claim 9,
determining tape end in case that a load on the monitoring of the driving motor is increased by a predetermined value or higher.

11. The tape printing control method according to claim 10,
determining tape end in case that the load on the monitoring of the driving motor is increased by the predetermined value or higher is maintained.
